(19) United States
(12) Patent Application Publication
(10) Pub. No.: US 2005/0060065 A1
(43) Pub. Date: Mar. 17, 2005

(54) Steps of setting for sprinkling period of sprinkler device

(76) Inventor: Wang King-Yuan, Chang-Hua City (TW)

Correspondence Address: Wang King-Yuan, PO BOX 487, Chang-Hua City, 500, TW

(21) Appl. No.: 10/651,959

(22) Filed: Sep. 2, 2003

(51) Int. Cl. G05D 7/00

(52) U.S. Cl. 700/284; 239/70; 700/16

(57) ABSTRACT

Steps for setting sprinkling of an automatic sprinkler includes step of pressing “RESET” button to clear the setting and operating “LEFT” and “RIGHT” shift buttons to set current date. The time is set by pressing “INCREASE” and “REDUCE” buttons the dates of period of sprinkling by pressing the “LEFT” and “RIGHT” shift buttons to set dates. Repeat the setting process for setting weekdays and weekend. When the pointer is shifted to positions of 2nd and 3rd, pressing the “RIGHT” button to remove the pointer. Press the “INCREASE” and “REDUCE” buttons to set the time of start and press the “ENTER” button when the pointer points at a first sprinkling position. Press the “INCREASE” and “REDUCE” buttons to set a period of time of sprinkling, and the pointer automatically pointing at “AUTO” position.

### FIELD OF THE INVENTION

The present invention relates to steps for setting patterns of sprinkling of an automatic sprinkler device.

### BACKGROUND OF THE INVENTION

A conventional automatic sprinkler device generally includes a complex setting processes and the user has to read the manual book before starting to set the details of patterns of sprinkling. The manual contains a lot of instructions and terms which are not similar to the users. There are so many buttons on the control timer so that the users usually spend a lot of time to successfully complete one setting. Once the user input a wrong instruction, it is not able to go back to the previous status and the user has to complete the whole setting process, then he or she can correct the wrong setting by carefully reading the manual book.

The present invention intends to provide an instructional way to set the automatic sprinkler and all the information can be displayed on the screen so that the user can easily complete the setting without spending too much time.

### SUMMARY OF THE INVENTION

The present invention relates to steps for setting sprinkling of an automatic sprinkler and includes step of pressing “RESET” button, step of operating “LEFT” and “RIGHT” shift buttons to set current date and pressing “ENTER” button, step of pressing “INCREASE” and “REDUCE” buttons to set time and pressing the “ENTER” button, step of setting dates of period of sprinkling by pressing the “LEFT” and “RIGHT” shift buttons to set dates and pressing the “ENTER” button, repeating the setting process for weekdays and weekend, when the pointer is shifted to positions of 2nd and 3rd, pressing the “RIGHT” button, step of pressing the “INCREASE” and “REDUCE” buttons to set the time of start and pressing the “ENTER” button when the pointer points at a first sprinkling position, pressing the “INCREASE” and “REDUCE” buttons to set a period of time of sprinkling, and the pointer automatically pointing at “AUTO” position.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the sprinkler with a controller connected thereto;

FIG. 2 shows the display on the display screen of the controller;

FIG. 3 shows the circuit of the controller;

FIG. 4 shows flow chart of the steps for controlling the sprinkler, and

FIG. 5 shows the sprinkler is in use.

### DETAILED DESCRIPTION OF THE PREFERRED EMBODIMENT

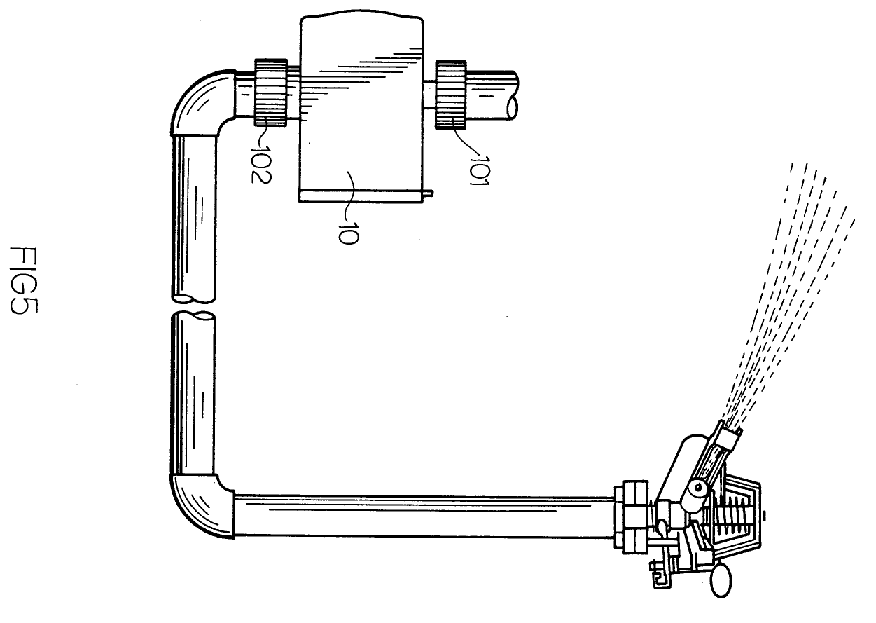

Referring to FIG. 5, the sprinkler of the present invention comprises a controller 10 which is connected to the pipe and a first connection port 101 is able to be connected to a faucet and a second connection port 102 is connected to the sprinkler.

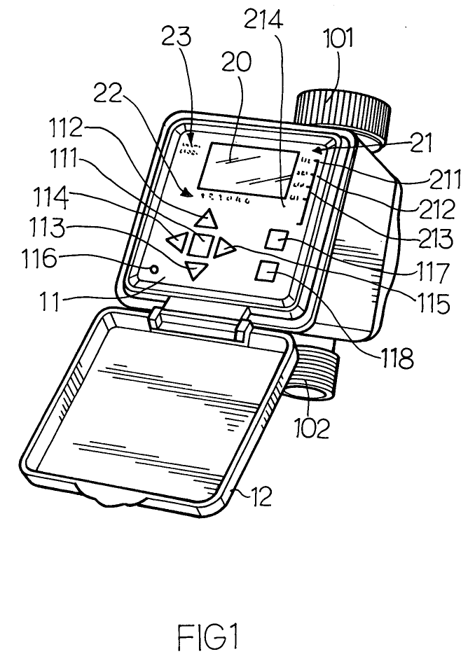

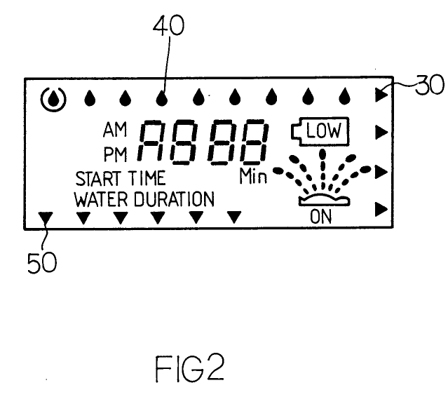

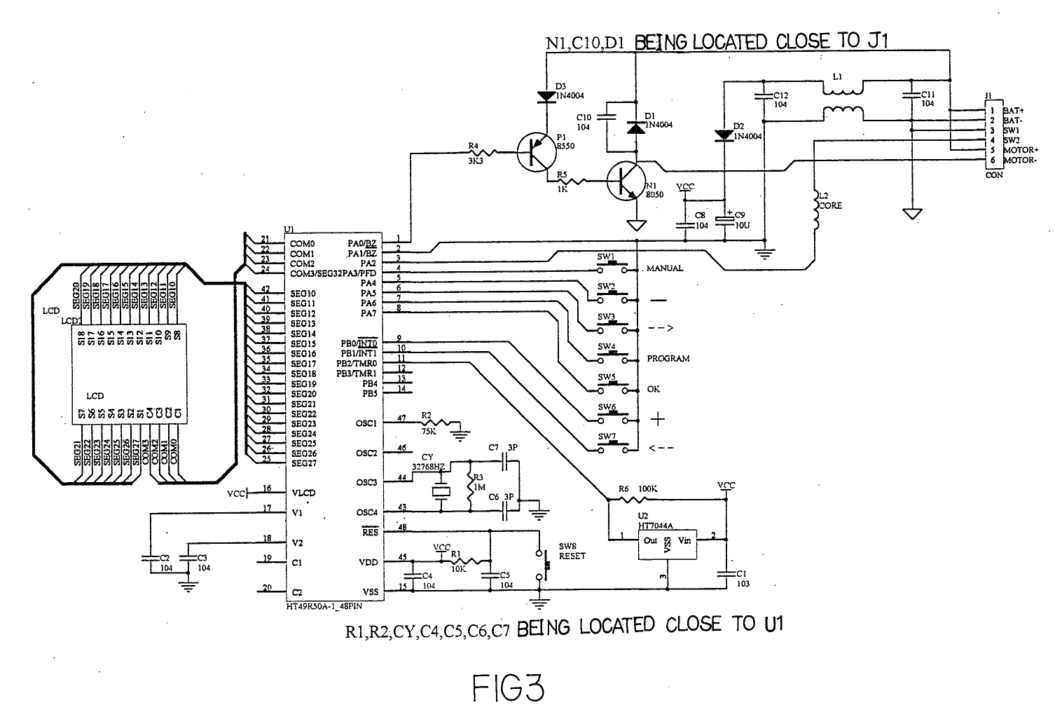

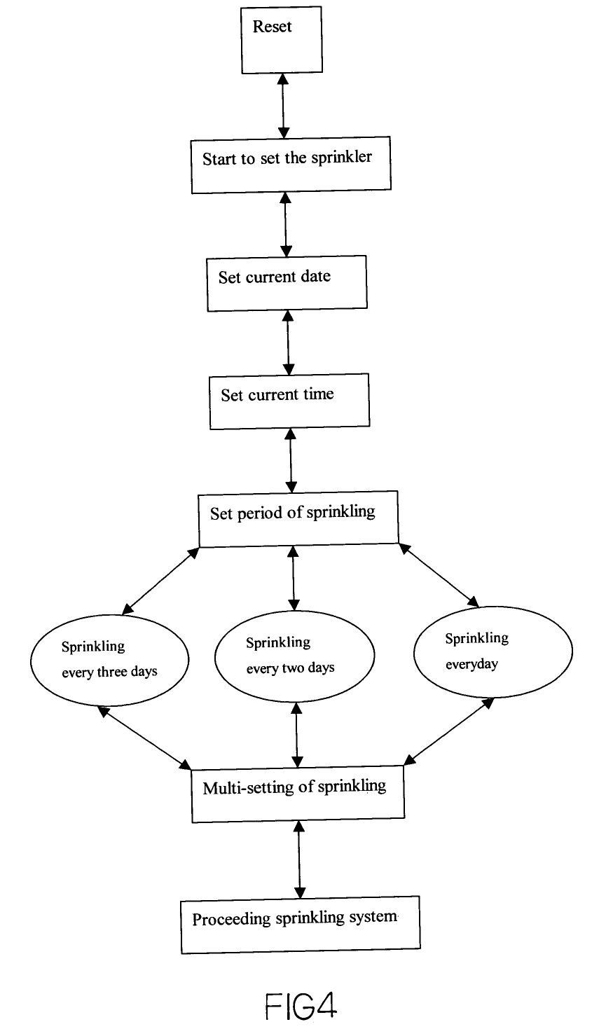

Referring to FIGS. 1 to 4, the controller 10 has a cover 12 which is pivotably connected to the controller 10 so as to cover the control panel 11 and the display screen 20. The panel 11 includes a “RESET” button, “LEFT” and “RIGHT” shift buttons 114, 115, “INCREASE” and “REDUCE” buttons 112, 113, “PROGRAM” button 117 and a “MANUAL” button 118. Around the display screen 20 are a function area 21, a sprinkling area 22 and a period area 23. The function area 21 includes “SET” position 211, “TEST” position 212, “AUTO” position 213, and “OFF” position 214.

The steps for setting the sprinkling includes:

step 1: pressing the “RESET” button 116 and a pointer 30 on the display screen 20 being positioned at the ready to set position in the function area 21;

step 2: pressing the “PROGRAM” button 117 to move the pointer 30 to the “SET” 211 in a mold system of the function area 21;

step 3: operating the “LEFT” and “RIGHT” shift buttons 114, 115 to set current date and pressing the “ENTER” button 111;

step 4: pressing the “INCREASE” and “REDUCE” buttons 112, 114 to set time and pressing the “ENTER” button 111;

step 5: setting date of period by pressing the “LEFT” and “RIGHT” shift buttons 114, 115 to set date and pressing the “ENTER” button 111, repeating the setting process for weekdays and weekend. When the mark 40 is shifted to positions of 2nd and 3rd, pressing the “RIGHT” button 115 to let the mark 40 escape;

If the sprinkler is set to sprinkle every two days, the processes are pressing the “LEFT” and “RIGHT” shift buttons 114, 115 to shift the mark 40 to point at 2nd position and then the “ENTER” 111 is pressed to complete the setting,

If the sprinkle is set to sprinkle every three days, the setting processes are pressing the “LEFT” and “RIGHT” shift buttons 114, 115 to make the mark 40 move to 3rd position and pressing the “ENTER” button 111.

step 6: pressing the “INCREASE” and “REDUCE” buttons 112, 113 to set the time of start and pressing the “ENTER” button 111 when the mark at a first sprinkling position, pressing the “INCREASE” and “REDUCE” buttons 112, 113 to set a period of time of sprinkling;

step 7: the pointer 30 automatically pointing at “TEST” position 212 in the function area 21 to allow the user to confirm the setting and then the pointer 30 points at the “AUTO” position 213 and the sprinkle is activated according the settings.

If the “PROGRAM” button is pressed, the pointer 30 is shifted to “OFF” position 214 and the setting is reserved and the sprinkle is not operated.

It is convenient for the user to jump the pointer 30 between the steps by pressing the “LEFT” and “RIGHT” shift buttons 114, 115.

If the “MANUAL” button 118 is pressed while the sprinkle is not in use, the sprinkle is activated and starts to sprinkle. If the “MANUAL” button 118 is pressed while the sprinkle is sprinkling, the sprinkling is stopped. If the automatic sprinkling instruction and the manual instruction are conflict, the manual instruction is prior than the automatic sprinkling instruction. When the manual sprinkling is terminated, the pointer 30 will positioned the previous status.

The user may check the period of sprinkling at any time by pressing “PROGRAM” button 117 and moving the pointer 30 to “TEST” position, all the settings will be displayed on the display screen 20.

The user may amend the setting by pressing “PROGRAM” button 117 and moving the pointer 30 to “SET” position to amend the previous settings.

While we have shown and described the embodiment in accordance with the present invention, it should be clear to those skilled in the art that further embodiments may be made without departing from the scope of the present invention.

1. Steps for setting an automatic sprinkler, comprising:
step 1: pressing “RESET” button and a pointer on a screen pointing at “SET” in a mold system of a function area;
step 2: operating “LEFT” and “RIGHT” shift buttons to set current date and pressing “ENTER” button;
step 3: pressing “INCREASE” and “REDUCE” buttons to set time and pressing the “ENTER” button;
step 4: setting dates of period by pressing the “LEFT” and “RIGHT” shift buttons to set dates and pressing the “ENTER” button, repeating the setting process for weekdays and weekend, when a mark of sprinkling is shifted to positions of 2nd and 3rd, pressing the “RIGHT” button and the “ENTER” button in sequence respectively;
step 5: pressing the “INCREASE” and “REDUCE” buttons to set the time of start and pressing the “ENTER” button when the mark of sprinkling is positioned at a first sprinkling position, pressing the “INCREASE” and “REDUCE” buttons to set a period of time of sprinkling, and
step 6: the pointer automatically pointing at “AUTO” position.

2. The steps as claimed in claim 1, wherein the sprinkler sprinkles every two days by pressing the “LEFT” and “RIGHT” shift buttons to shift the pointer to point at 2nd position and then the “ENTER” is pressed to complete the setting, when the pointer moves to 3rd position, pressing the “LEFT” and “RIGHT” shift buttons to move the pointer to set the period of sprinkling.

3. The steps as claimed in claim 1, wherein the sprinkler sprinkles every three days by pressing the “LEFT” and “RIGHT” shift buttons to shift the pointer to point at 3rd position and then the “ENTER” is pressed to complete the setting, when the pointer moves to 3rd position, pressing the “LEFT” and “RIGHT” shift buttons to move the pointer to set the period of sprinkling.

4. The steps as claimed in claim 1, wherein the pointer jumps between the steps by pressing the “LEFT” and “RIGHT” shift buttons.
